(19) United States
(12) Patent Application Publication
(10) Pub. No.: US 2019/0083995 A1
(43) Pub. Date: Mar. 21, 2019

(54) FOAM DISPENSERS

(71) Applicant: RIEKE PACKAGING SYSTEMS LIMITED, Leicestershire (GB)

(72) Inventor: Simon Christopher KNIGHT, Glamorgan (GB)

(21) Appl. No.: 16/082,985

(22) PCT Filed: Mar. 8, 2017
(86) PCT No.: PCT/EP2017/055480

§ 371 Date: Sep. 7, 2018

(30) Foreign Application Priority Data
Mar. 8, 2016 (GB) 1603949.7

(51) Int. Cl. B05B 7/00; B05B 11/00

(52) U.S. Cl. CPC B05B 7/0037; B05B 11/3087; B05B 11/3074; B05B 11/3059; B05B 11/0008; B05B 11/00442; B05B 11/3047; B05B 11/0064

(57) ABSTRACT

A foam dispenser has a pump body and a sprung plunger (2). A one-piece moulded cylinder component (31) comprises a larger diameter portion (32) for an air cylinder and a smaller diameter portion (33) for a liquid cylinder. The plunger (2) carries respective pistons (22,21) movable in the air cylinder and liquid cylinder to pump air and liquid through valved outlets to a mixing chamber (8) in the plunger for foam production. The liquid cylinder has a discrete inlet piece (9) including an inlet valve. The liquid outlet valve is operated by a valve pin (25) connected to a valve pin retainer (39) which is formed integrally as a one-piece moulding with the cylinder component (31).

This invention has to do with foam dispensers, of the kind which pump foam from a manual plunger-operated pump adapted to combine air with foamable liquid drawn from a container of the dispenser.

### BACKGROUND

Hand-operated foamers (foam dispensers) are widely used for dispensing foams of toiletries, bathroom products and the like by manual pump action using a foamable liquid in a container and air from the surroundings. The pump plunger carries an air piston and a liquid piston, operating respectively in an air cylinder and a liquid cylinder of the pump body. The air chamber and liquid chamber have outlets to a mixing region where air and liquid mix to form a precursor foam, which passes through a regulator (typically one or more meshes) and to a discharge nozzle. The outlets and discharge nozzle are usually part of the plunger. The volume of air needed is much larger than that of liquid, and since the air and liquid pistons are operated by the stroke of the same plunger the air cylinder has a much larger diameter than the liquid cylinder. Usually the air and liquid cylinders are formed together coaxially in one piece, as portions of a moulded cylinder component having the air cylinder at the top, the liquid cylinder at the bottom and a transition region of diameter reduction between them, often with an upwardly re-entrant wall to reduce pump height. The bottom end of the liquid cylinder has an inlet portion defining a liquid inlet (usually connected to a dip tube) with an inlet valve, usually a ball valve.

See for example our US2011/0272432A, and FIG. 5 herein where a similar foamer is shown. The drawing figures show only the pump of the dispenser; it will be understood throughout this disclosure that a container for liquid is included to make up the dispenser, and may be of conventional type.

In the prior art dispenser of FIG. 5 the liquid outlet is controlled by a valve operated by a valve pin 125 whose top end 2501 has a tapered head enlargement, acting as a valve member to close or open the outlet, while its bottom end has a retaining enlargement 2503 held slidably in a retainer tube 139 standing up from the bottom end of the liquid chamber. The shaft of the valve pin 125 extends down through the hollow liquid piston of the plunger stem, in the liquid chamber. Other types of foamer use different outlet valves, such as a sliding sleeve on the plunger stem which moves with a liquid piston acting against the liquid cylinder wall, to cover or uncover an entry opening into an outlet passage in the stem. This also works well, but when the foamable liquid is slippery, piston wall friction may not be enough to open the sliding seal reliably and the valve pin version is then preferred.

A further feature in FIG. 5 is that the pump return spring 105 is mounted around the valve pin in the liquid chamber 1211. This enables the spring to be used to hold down the pin retainer tube 139, which is a discrete part: integral moulding of this pin retainer tube is impractical. (Moulding the illustrated inlet formation with the valve seat is already problematic, as discussed below.) The spring then contacts the liquid, which for some products is undesirable.

See also U.S. Pat. No. 6,053,364.

### THE INVENTION

In this application we propose new features for a foam dispenser and foam pump.

Some aspects of our proposals are set out in the claims.

In one aspect, our proposals enable a pump spring to be positioned outside the liquid chamber, in conjunction with the use of a pin-operated liquid outlet valve. In another aspect, our proposals enable improved manufacture of the liquid inlet of the pump body.

The invention relates to a foam dispenser of the type comprising a pump body and a pump plunger reciprocable relative to the pump body;

the pump body comprising an air cylinder and a liquid cylinder respectively defining an air chamber and a liquid chamber, the liquid cylinder having an inlet portion providing an inlet for receiving liquid from a container of liquid to be foamed, and including an inlet valve, and

the pump plunger comprising an air piston movable in the air cylinder to vary the volume of the air chamber and a liquid piston operable in the liquid cylinder to vary the volume of the liquid chamber.

As is known, the dispenser pump generally has a mixing region, preferably a mixing chamber, for mixing air and liquid under turbulent conditions to form foam. One or more air outlets lead from the air chamber to the mixing region, and one and more liquid outlets lead from the liquid chamber to the mixing region. From the mixing region, an outlet passage leads to a discharge nozzle for the foam, preferably via a foam regulator e.g. in the form of one or more permeable structures such as meshes extending across the outlet passage. Preferably the air and liquid outlets, the mixing region and the outlet passage are incorporated in the pump plunger.

The dispenser pump comprises a pump spring biasing the plunger towards an extended position relative to the body, usually with a lower end acting against the pump body and an upper end acting against the pump plunger.

In one of our proposals herein, in relation to a foam dispenser of the type described, the pump body comprises a cylinder component which is a one-piece moulded component comprising a larger diameter air cylinder portion, a smaller diameter liquid cylinder portion and a diameter transition portion (i.e. with a radial direction component) which generally constitutes a bottom of the air cylinder, and which may be or may comprise a re-entrant wall portion so as to form an outer annular trough and an inner annular ridge, the ridge being at or adjacent the top of the liquid cylinder. We propose that the inlet portion of the liquid cylinder, including an inlet valve formation, is comprised in a discrete inlet piece which connects to the liquid cylinder portion of the cylinder component to define the liquid chamber and complete the liquid cylinder with its inlet.

The discrete inlet piece is generally a one-piece tubular moulding. It may have an upwardly-directed fitting to connect to the cylinder component, usually of a larger diameter, and a downwardly-directed region or portion, usually of a smaller diameter, which may be a dip tube connector for connection to a dip tube for liquid intake. It comprises an inlet valve formation, usually comprising a downwardly-convergent valve seat, for an inlet valve member typically a ball. The valve seat typically is or comprises a conical surface. The inlet piece may also define an inlet flow restriction or flow orifice, below (upstream of) the valve seat. The corresponding formation may be an inward annular flange with the flow orifice at its centre, and which may act as a stop for dip tube push-insertion. The upper part of the inlet piece is adapted to fix in a liquid-tight manner to the liquid cylinder portion of the cylinder component, e.g. by a snap fit. It may have an upward skirt or collar fitting around or into a corresponding downward skirt or collar of the cylinder component, e.g. with snap formations on the two components.

This proposal offers advantages in moulding the liquid inlet valve region. Moulding of this region requires accurate formation of the tapered valve seat, leading down to the inlet flow restriction where a mould pin must be inserted to form the orifice. Conventionally it is necessary to vent air at that point to avoiding air trapping in the mould, so that there is a risk of flashing at the vent point. Moulding the cylinder component, which has substantial diameter and area and a convoluted form, is in any case challenging. Moulding material must flow over a large area in a relatively thin layer. To achieve this, material is usually injected at multiple points at an intermediate position of the structure, such as around the bottom of the air cylinder wall portion. However the liquid inlet portion is still remote from the injection points at an extremity of the mould, hence the mentioned need for venting, and it has been difficult to achieve accurate moulding quality of the inlet valve formation. By providing an inlet portion instead as a separate piece, a good quality inlet valve formation can be made more easily because it need not be part of a large and complex component.

The discrete inlet piece is also advantageous when the liquid outlet has a valve operated by a valve pin connected to a valve pin retainer in the liquid chamber. This valve retainer needs to be held down in the liquid chamber, but because it is not practicable to mould it integrally it has generally been a separate component, held down (as mentioned above) by acting as a bottom abutment for a pump spring. Provision of the inlet as a discrete piece enables the valve pin retainer to be formed integrally, preferably integrally with the liquid cylinder portion of the cylinder component (although it might alternatively be integrated with the inlet piece) so that firstly, component count is not increased by having the discrete inlet piece and secondly, the pump spring is not needed to hold it and can be outside the liquid chamber. Desirably the pump spring is positioned in the air chamber, resting on the bottom of the air chamber e.g. around the pump plunger stem (e.g. around a liquid piston portion of the plunger), such as at an inner annular ridge of the transition portion of the cylinder component that connects between the large diameter and small diameter portions. Accordingly, where a valve pin-operated liquid outlet valve is used, our proposal enables convenient disposition of the pump spring outside the liquid chamber.

A second aspect of our proposals, in relation to a foam dispenser of the type described, is that the liquid outlet has a liquid outlet valve operated by a valve pin connected to a valve pin retainer in the liquid chamber downstream of the inlet valve, and the pump spring is positioned in the air chamber. A bottom end of the pump spring preferably acts against the pump body at the bottom of the air chamber, such as around the pump plunger and especially around a liquid piston portion of the plunger. The pump spring bottom end may engage an inner annular ridge of a re-entrant wall comprised in a transition portion of the cylinder component that connects between larger diameter and smaller diameter portions constituting the air cylinder and liquid cylinder respectively.

Features and preferred features described above for the first aspect are of course also applicable with the second aspect since they are compatible and advantageously combined.

### DESCRIPTION OF THE DRAWINGS

An example of our proposals is now described with reference to the accompanying drawings, in which:

FIG. 1 is a perspective view of a foam dispenser pump;

FIG. 2 is an axial cross-section through the dispenser pump of FIG. 1;

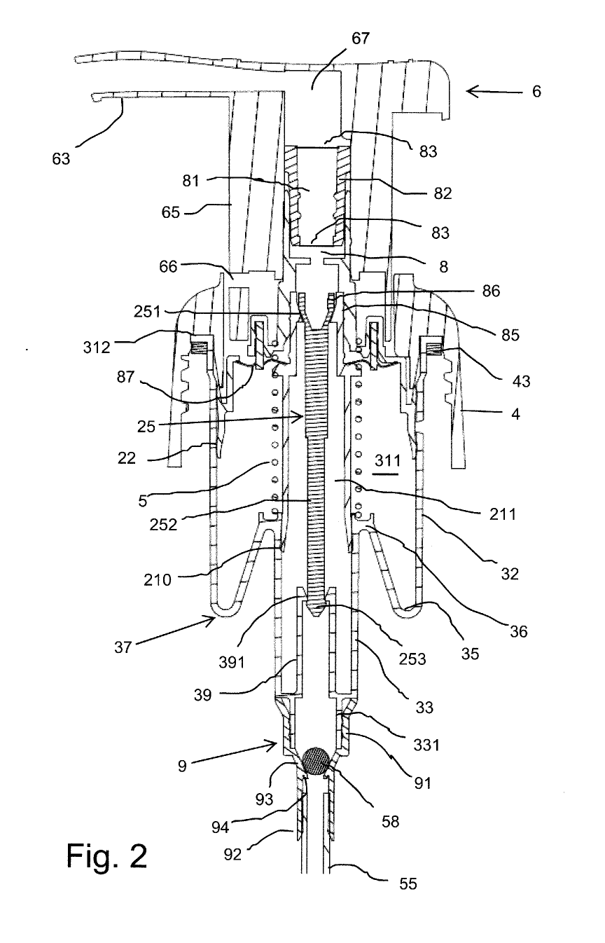

FIG. 3 is an exploded perspective view showing the upper components of the pump;

FIG. 4 is an exploded perspective view showing lower components of the pump, and

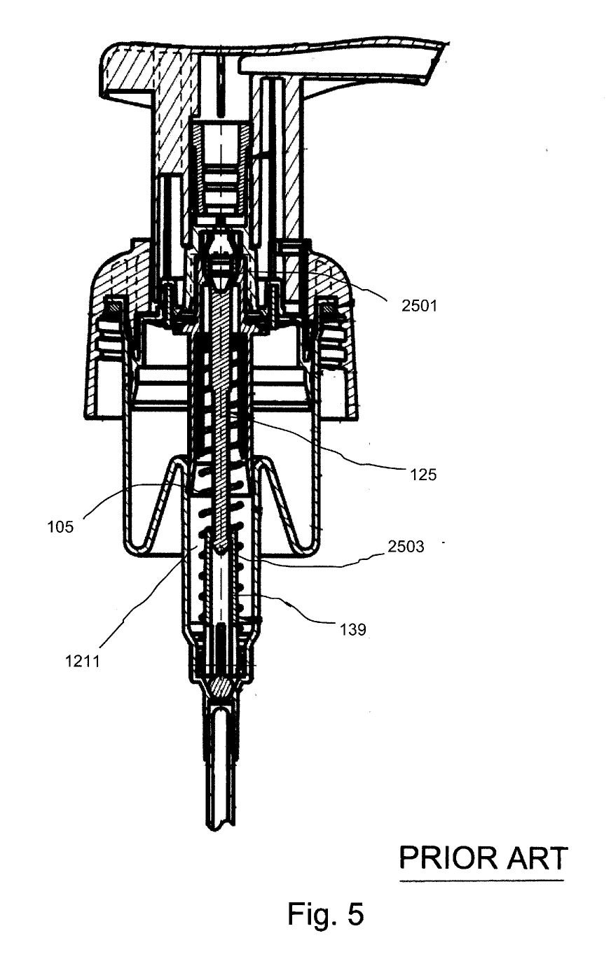

Fig. shows a prior art foamer design, already discussed.

### DETAILED DESCRIPTION

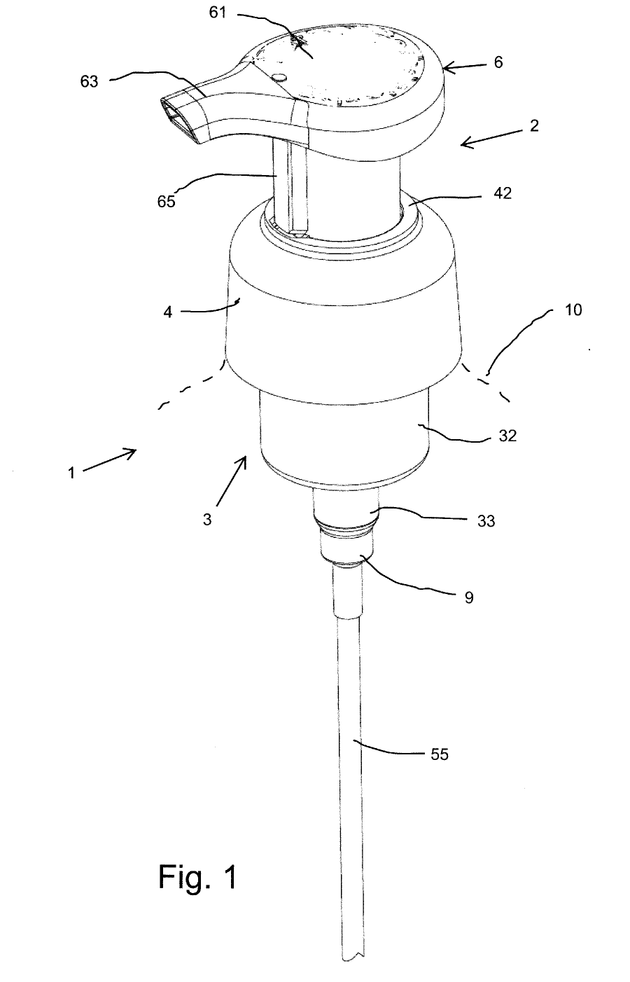

The foam dispenser consists of a foam pump 1 mounted on a container 10 which contains a foamable liquid, to be drawn into the pump 1 through a dip tube 55. The container is indicated only schematically in FIG. 1. The pump 1 consists of a body 3, fixedly mounted to a neck of the container by a closure cap 4, and a plunger 2 with an actuator head 6 having a push top 61 and a nozzle 63.

The closure cap 4 holds the body component down onto the edge of the neck of the container through an outward top flange 312 of the body component and a seal ring 43.

The pump body 3 consists of a main cylinder component 31 including a larger diameter air cylinder portion 32 with a cylindrical outer wall and a coaxial smaller-diameter liquid cylinder portion 33, also with a cylindrical outer wall and terminating at a downward spigot 331. A re-entrant transition wall 37 extends between the larger diameter and smaller diameter portions, defining an outer annular trough 35 and an inner annular ridge 36. A liquid cylinder of the dispenser is completed by an inlet piece 9 which is a generally tubular moulded part consisting of a lower dip tube socket 92, a top fitting in the form of a socket 91 which fits with a snap onto the downward spigot 331 of the cylinder component, and a convergent valve seat portion 93 between them which forms, on the inside, a conical valve seat surface for a valve ball 58 and a restricted flow orifice 94 immediately below the valve.

It is a particular feature here that the inlet piece 9 is separately moulded, so that long mould flow paths are avoided in the delicate operation of forming the valve region.

The plunger 2 moves in the body 3 between extended and retracted positions (the extended position being shown) and carries an outer (upper) air piston 22 and an inner (lower) liquid piston 21 forming a hollow stem, with a bottom annular lip 210 which wipes the wall of the liquid cylinder 33. The internal cavity of the liquid piston 21 constitutes, with the liquid cylinder 33, a liquid chamber 211 which communicates upwardly via a liquid outlet 86 with a mixing chamber 8. The mixing chamber 8 is the beginning of an outlet passage 67 leading to the discharge nozzle 63 via a foam regulator 81. The foam regulator 81 may be of any known type; that shown is a conventional insert comprising meshes 83 on either end of a sleeve 82 which fits into the plunger head 6.

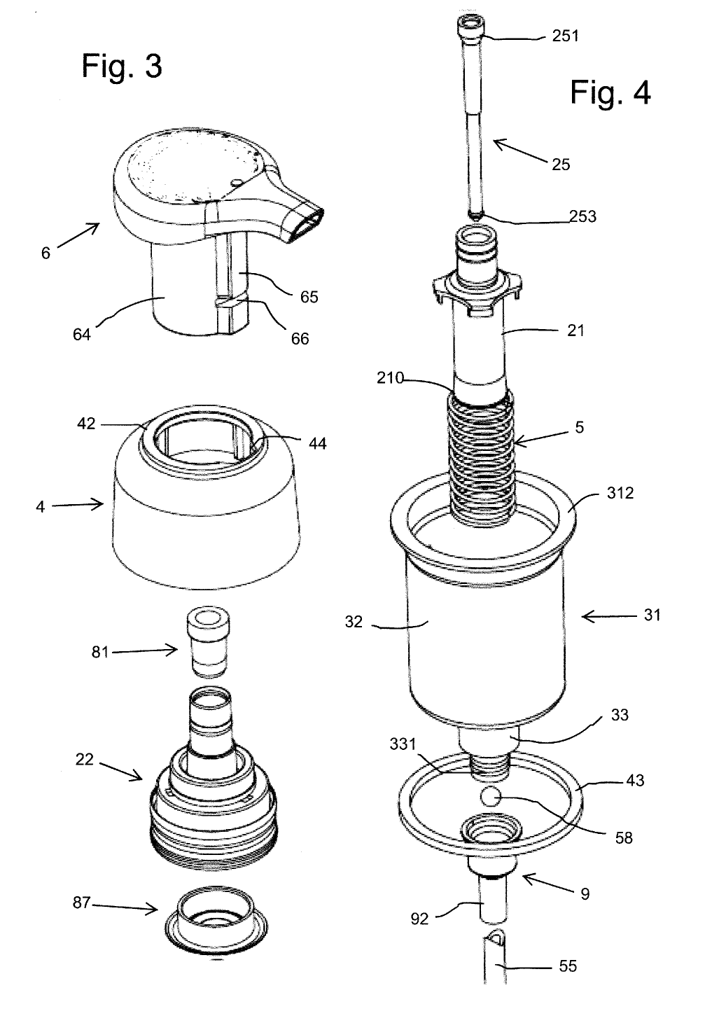

The plunger 6 has a shroud 64 with a front axial rib 65, fitting down through a locking flange 42 and a corresponding slot 44 of the closure cap 4. In the plunger-extended position the plunger can be turned so that a locking slot 66 (see FIG. 3) slides onto the locking flange 42 and prevents depression of the plunger.

The air piston 22 (see also FIG. 3) has a generally domed shape constituting a central portion of the plunger, and receives a coaxial air valve ring 87 comprising inward and outward annular elastomer flaps which act as an inlet valve and an outlet valve for air flow vis à vis the air chamber 311 defined in the air cylinder 32. On the plunger upstroke, air flows into the air chamber 311 in a known manner through clearances in and around the plunger head and then through the air inlet valve. On the plunger downstroke air is driven out of the air chamber 311 via air outlet channels 85 defined between the liquid piston and air piston components 21,22, entering the mixing chamber 8 at speed to mix with the liquid between the liquid outlet 86 and the foam regulator 81.

Valves for the liquid flow are provided by the inlet ball valve 58,93 at the inlet piece 9, and by a valve pin 25 comprising an elongated shaft 252 with a tapered head 251 acting as a liquid outlet valve member seating in the liquid outlet 86. The pin 25 has a retaining enlargement 253 at the bottom end which is trapped by an inward flange 391 at the top of an upwardly-projecting retainer tube 39; the bottom end of the valve pin is snapped into this tube during assembly and retained thereafter.

A feature of this construction is that the upstanding retainer tube 39 for the pin 25 is moulded in one piece with the main cylinder component 31, as a re-entrant formation of the bottom end of the liquid cylinder portion 33 thereof. This obviates having a separate component for the pin retainer, which has previously been necessary in dispensers using one-piece liquid cylinder portions.

The pump spring 5, to compress during depression of the plunger and urge the plunger back to the extended position afterwards, is housed in the air chamber 311 surrounding the liquid piston 21 so that it is out of the liquid flow path. Its bottom end rests on a spring seat 36 provided on the inner annular ridge of the re-entrant transition wall 37 of the body component 31, around the top of the liquid cylinder portion.

Operation of the dispenser proceeds according to known principles. After a preliminary depression of the plunger, the plunger re-extends driven by the spring, drawing liquid into the liquid chamber 211 and air into the air chamber 311 through the corresponding inlet valves. As the plunger extends, the valve member 251 at the top of the valve pin 25 is drawn down to seal the liquid outlet 86.

Subsequently the plunger 6 is depressed by pushing on the push top 61. Liquid pressure lifts the valve member 251 of the valve pin 25 off its seat, so that liquid jets into the mixing region 8 at the same time as air under pressure is driven into the same region from the air outlets 85 via the air outlet valve. The turbulent mixing of the air and liquid forms a foam precursor which is then made more uniform and adjusted in bubble size by passing through the regulator meshes 83, subsequently passing out through the outlet channel 67 to the discharge nozzle 63.

1. Foam dispenser comprising:
a pump body including an air cylinder defining an air chamber, a liquid cylinder defining a liquid chamber, and an inlet portion including an inlet valve receiving liquid into the liquid cylinder from a container of liquid to be foamed;
a pump plunger reciprocable relative to the pump body including an air piston movable in the air cylinder to vary the volume of the air chamber and a liquid piston operable in the liquid cylinder to vary the volume of the liquid chamber,
wherein the pump body includes a one-piece moulded cylinder component including a larger diameter portion to define said air cylinder, a smaller diameter portion to define said liquid cylinder and a transition portion between the larger diameter portion and the smaller diameter portion and a discrete inlet piece connected to the smaller diameter portion of said cylinder component, the discrete inlet piece forming said inlet portion and an inlet valve formation thereof.

2. Foam dispenser of claim 1 wherein the discrete inlet piece is a one-piece tubular moulding.

3. Foam dispenser of claim 1 wherein the discrete inlet piece has an upwardly-directed fitting connecting to the cylinder component and a downwardly-directed dip tube connector.

4. Foam dispenser of claim 3 wherein the upwardly-directed fitting is a socket connected to a downward spigot of the cylinder component.

5. Foam dispenser of claim 1 in which the inlet valve formation has a downwardly-convergent valve seat for an inlet valve member.

6. Foam dispenser of claim 5 in which the inlet valve formation comprises an inward annular flange having a flow orifice at its center and forming a stop for an inserted dip tube.

7. Foam dispenser of claim 1 in which the transition portion of the one-piece moulded cylinder component comprises a re-entrant wall portion thereof forming an outer annular trough and an inner annular ridge.

8. Foam dispenser of claim 1 wherein the pump has a mixing chamber for mixing air and liquid under turbulent conditions to form foam, one or more air outlets leading from the air chamber to the mixing chamber and one and more liquid outlets leading from the liquid chamber to the mixing chamber, and
a liquid outlet valve operated by a valve pin connected to a valve pin retainer in the liquid chamber.

9. Foam dispenser of claim 8 in which the valve pin retainer is formed integrally as a one-piece moulding with the cylinder component, or is formed integrally as a one-piece moulding with the discrete inlet piece.

10. Foam dispenser of claim 8 in which the valve pin retainer is formed integrally as a one-piece moulding with the cylinder component as a re-entrant formation in the bottom end of the smaller diameter portion thereof.

11. Foam dispenser claim 1 wherein a pump spring with an end acting against the pump body and an end acting against the pump plunger to bias the plunger towards an extended position relative to the pump body, the pump spring being outside the liquid chamber.

12. Foam dispenser of claim 11 in which the pump spring is in the air chamber.

13. Foam dispenser comprising:
a pump body, a pump plunger reciprocable relative to the pump body and a pump spring biasing the pump plunger towards an extended position relative to the pump body;
wherein the pump body has an air cylinder defining an air chamber and a liquid cylinder defining a liquid chamber, and an inlet portion including an inlet valve and being for receiving liquid into the liquid cylinder from a container of liquid to be foamed, and
wherein the pump plunger has an air piston movable in the air cylinder to vary the volume of the air chamber and a liquid piston movable in the liquid cylinder to vary the volume of the liquid chamber;
wherein a mixing chamber being defined in the pump plunger for mixing air and liquid under turbulent conditions to form foam, one or more air outlets leading from the air chamber to the mixing chamber and one and more liquid outlets leading from the liquid chamber to the mixing chamber via a liquid outlet valve; and
wherein the liquid outlet valve is operated by a valve pin connected to a valve pin retainer in the liquid chamber downstream of the inlet valve, and the pump spring is positioned in the air chamber.

14. Foam dispenser of claim 13 wherein a bottom end of the pump spring acts against the pump body at the bottom of the air chamber.

15. Foam dispenser of claim 14 wherein the pump body further comprises a one-piece moulded cylinder component comprising a larger diameter portion to define said air cylinder, a smaller diameter portion to define said liquid cylinder and a transition portion between the larger diameter portion and the smaller diameter portion, the transition portion comprising a re-entrant wall portion forming an outer annular trough and an inner annular ridge, and wherein said bottom end of the pump spring acts against said inner annular ridge.

16. Foam dispenser of claim 15 wherein the valve pin retainer is formed in one piece with the smaller diameter portion of the cylinder component.
